(19) United States
(12) Patent Application Publication
(10) Pub. No.: US 2010/0090583 A1
(43) Pub. Date: Apr. 15, 2010

(54) Green phosphor for plasma display panel, green phosphor composition including the same, and plasma display panel including the same

(76) Inventors: Myung-Hun Bae, Suwon-si (KR); Chang-Hwan Kim, Suwon-si (KR); Young-Chul You, Suwon-si (KR); Soon-Goon Park, Suwon-si (KR); Sang-Il Lee, Suwon-si (KR); Hyun-Gyu Kim, Suwon-si (KR); Sung-Wook Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/588,239

(22) Filed: Oct. 8, 2009

(30) Foreign Application Priority Data
Oct. 10, 2008 (KR) 10-2008-0099550

(51) Int. Cl. H01J 1/62; C01F 17/00; C09K 11/77

(52) U.S. Cl. 313/487; 423/263; 252/301.4 R; 252/301.6 F

(57) ABSTRACT

A green phosphor for a plasma display panel (PDP), a green phosphor composition including the same, and a PDP including the same, the green phosphor including a green phosphor represented by Formula 1: (Lu₃₋ₓ,Ceₓ)Al₅O₁₂, wherein in Formula 1, x satisfies the relation 0<x<3.

### BACKGROUND

1. Field

Embodiments relate to a green phosphor for a plasma display panel (PDP), a green phosphor composition including the same, and a PDP including the same.

2. Description of the Related Art

Phosphors emit light when they are exposed to energy, e.g., ultraviolet (UV) rays. In general, phosphors may be used in light sources, e.g., mercury fluorescent lamps and mercury-free fluorescent lamps, electron emission devices, PDPs, etc. In the future, phosphors may be used for a wider range of applications as new multimedia devices are developed.

PDPs are flat panel displays that display images using light emitted by phosphors exposed to UV rays. The UV rays may be created by a discharge of a mixture of gases including, e.g., neon and xenon, injected into an area between a pair of glass substrates. Visible light may be created by each phosphor using resonance radiation light of xenon ion (147 nm vacuum ultraviolet rays).

A phosphor for a PDP, particularly, a phosphor for a three dimensional (3D) PDP may need to have excellent discharge properties, emission luminance, and chromaticity coordinate, as well as a short decay time. ZnSi₂O₄:Mn (ZSM) phosphors have typically been used as a green phosphor for PDPs. The color purity, luminance, lifetime, and decay properties of ZSM phosphors vary according to the concentration of Mn in the phosphor. When the decay time of a ZSM phosphor is reduced by adjusting the concentration of Mn in the ZSM phosphor, the resulting ZSM phosphor may in turn exhibit poor color purity and luminance, as well as an undesirably short lifetime. When the decay time of a ZSM phosphor is increased by adjusting the concentration of Mn in the ZSM phosphor, undesirable afterglow may become visible. A green phosphor, which is a combination of ZSM and YBO₃:Tb, has also typically been used. However, when ZSM is used in combination with YBO₃:Tb, since the overall decay time increases, the decay time of ZSM may need to be reduced. Combined phosphors of Zn2SiO₄:Mn and YBO₃:Tb having reduced decay time may therefore have poorer chromaticity coordinate than ZSM used alone.

### SUMMARY

Embodiments are therefore directed to a green phosphor for a PDP, a green phosphor composition including the same, and a PDP including the same, which substantially overcome one or more of the problems due to the limitations and disadvantages of the related art.

It is therefore a feature of an embodiment to provide a green phosphor having excellent decay time and color purity properties.

At least one of the above and other features and advantages may be realized by providing a green phosphor for a plasma display panel (PDP) including a green phosphor represented by Formula 1: (Lu₃₋ₓ,Ceₓ)Al₅O₁₂, wherein in Formula 1, x satisfies the relation 0<x<3.

In Formula 1, x may satisfy the relation 0.001≦x≦0.5.

In Formula 1, x may satisfy the relation 0.001≦x≦0.05.

The green phosphor may have a median particle diameter D₅₀ of about 1 to about 4 μm.

At least one of the above and other features and advantages may also be realized by providing a green phosphor composition for a PDP including a first phosphor represented by Formula 1: (Lu₃₋ₓ,Ceₓ)Al₅O₁₂, wherein in Formula 1, x satisfies the relation 0<x<3, and a second phosphor including at least one of ZnSi₂O₄:Mn, YBO₃:Tb, BaMgAl₁₄O₂₃:Mn, and GdAl₃B₄O₁₂:Tb.

The first phosphor and the second phosphor may be included in a weight ratio of about 3:7 to about 7:3.

In Formula 1, x may satisfy the relation 0.001≦x≦0.5.

In Formula 1, x may satisfy the relation 0.001≦x≦0.05.

At least one of the above and other features and advantages may also be realized by providing a PDP including a front substrate, wherein the front substrate is transparent, a rear substrate parallel to the front substrate, discharge cells divided by barriers disposed between the front substrate and the rear substrate, address electrodes extending to correspond to the discharge cells disposed in one direction, a rear dielectric layer covering the address electrodes, red, green, and blue phosphor layers disposed in the discharge cells, pairs of sustain electrodes extending in a direction crossing the direction in which the address electrodes extend, a front dielectric layer covering the pairs of sustain electrodes, and a discharge gas filling the discharge cell, wherein the green phosphor layer includes a green phosphor represented by Formula 1: (Lu₃₋ₓ,Ceₓ)Al₅O₁₂, and in Formula 1, x satisfies the relation 0<x<3.

In Formula 1, x may satisfy the relation 0.001≦x≦0.5.

In Formula 1, x may satisfy the relation 0.001≦x≦0.05.

The green phosphor may have a median particle diameter D₅₀ of about 1 to about 4 μm.

The green phosphor layer may further include a second phosphor including at least one of ZnSi₂O₄:Mn, YBO₃:Tb, BaMgAl₁₄O₂₃:Mn, and GdAl₃B₄O₁₂:Tb.

The first phosphor and the second phosphor may be included in a weight ratio of about 3:7 to about 7:3.

In Formula 1, x may satisfy the relation 0.001≦x≦0.5.

In Formula 1, x may satisfy the relation 0.001≦x≦0.05.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of a PDP according to an embodiment;

FIG. 2 illustrates Table 1 showing a composition, CIE (x,y), relative luminance, and decay time for Comparative Example 1 and Examples 1 to 13.

### DETAILED DESCRIPTION

Korean Patent Application No. 10-2008-0099550, filed on Oct. 10, 2008, in the Korean Intellectual Property Office, and entitled: “Green Phosphor for Plasma Display Panel, Green Phosphor Composition Including the Green Phosphor, and Plasma Display Panel Including the Green Phosphor,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

An embodiment provides a green phosphor for a PDP, wherein the green phosphor is represented by Formula 1: (Lu₃₋ₓ,Ceₓ)Al₅O₁₂ (hereinafter, also referred to as LuAG:Ce).

A short decay time, preferably, about 4 ms or less, may be required for effectively realizing three-dimensional (3D) images on a PDP. (Y₃₋ₓ,Ceₓ)Al₅O₁₂ (hereinafter, also referred to as YAG:Ce) phosphors, which are green phosphors typically used in 3D PDPs, may have excellent decay time properties, e.g., about 0.1 ms or less. However, YAG:Ce phosphors have a chromaticity coordinate (CIE 0.415, 0.553) that corresponds to a yellow color, and thus a PDP using YAG:Ce phosphors may exhibit an undesirable yellow color overall.

When lutetium (Lu) is used instead of yttrium (Y) in a YAG:Ce phosphor, a green phosphor having improved color purity may be prepared. This is because the green phosphor including Lu may have a chromaticity coordinate relatively close to an ideal green chromaticity coordinate, i.e., around CIE (0.1, 0.8). When the green phosphor including Lu is used in a phosphor layer of a PDP, the PDP may have an advantageously widened color reproduction range.

In the green phosphor represented by Formula 1: (Lu₃₋ₓ,Ceₓ)Al₅O₁₂, x indicating an atomic ratio of Ce may be a real number of about 0 to about 3. Preferably, x is about 0.001 to about 0.5, and more preferably, about 0.001 to about 0.05. Maintaining the atomic ratio represented by x within these amounts may help ensure that the green phosphor may have a chromaticity coordinate close to an ideal green chromaticity coordinate, as well as excellent luminance.

Particles of the green phosphor represented by Formula 1: (Lu₃₋ₓ,Ceₓ)Al₅O₁₂, may have a median diameter D₅₀ that may be adjusted from about 1 to about 4 μm. Maintaining the particle size within these amounts may help ensure that the green phosphor is easily used in a typical PDP TV.

A method of preparing the green phosphor of an embodiment will now be described. First, Lu₂O₃, Al₂O₃, and CeO₂, as precursors, may be quantified according to chemical equivalent weight ratios so as to have a desired atomic ratio. Then, the precursors may be mixed using, e.g., a V-mixer, to form a mixture. If necessary, as a flux facilitating reaction, a fluoric compound, e.g., AlF₃ or MgF₂, a chloridic compound, e.g., NH₄Cl or BaCl₂, or a boronic compound, e.g., H₃BO₃ may be added to the mixture. Preferably, NH₄Cl is added to the mixture to help ensure that the green phosphor particles have a desired median diameter. Then, if necessary, the mixture may be heated at a temperature of about 1200° C. to about 1600° C. under an air atmosphere (oxidation condition), carbon (reduction condition), hydrogen, nitrogen, helium, neon, argon, or mixtures including, e.g., helium, neon, and argon. Heating under one of these atmospheres may, e.g., decrease an x-coordinate and increase a y-coordinate in a green chromaticity coordinate of a resultant phosphor, in order to achieve a color close to the ideal green chromaticity coordinate. Preferably the mixture is heated under a carbon atmosphere. The carbon atmosphere may be defined as a condition in which the mixture of the precursors are heated with carbon, e.g., charcoal. A green phosphor layer for a PDP may be prepared by baking the mixture at a temperature of about 1200° C. to about 1600° C. for about two to about twelve hours.

In order to manufacture a PDP, a LuAG:Ce phosphor (a first phosphor) may be used either alone or in combination with another phosphor (a second phosphor) to form a phosphor composition. The second phosphor is not limited to any particular phosphor. The second phosphor may include, e.g., ZnSi₂O₄:Mn, YBO₃:Tb, BaMgAl₁₄O₂₃:Mn, GdAl₃B₄O₁₂:Tb, or the like. Preferably the second phosphor includes ZnSi₂O₄:Mn, because of its desirable effect on luminance and chromaticity coordinate.

A weight ratio of the first phosphor to the second phosphor may be determined so that the resulting combination thereof may have desirable emissive properties, e.g., chromaticity coordinate, luminance, decay time, etc. However, the weight ratio is not limited to any particular weight ratio. The weight ratio may be about 3:7 to about 7:3. For example, when the second phosphor includes only one kind of phosphor, a weight ratio of the first phosphor and the second phosphor may be about 4:6 to about 6:4, and preferably, about 5:5. Alternatively, when the second phosphor includes two kinds of phosphors, a weight ratio of the first phosphor and one of the phosphors included in the second phosphor may be about 4:6 to about 6:4, and preferably, about 5:5. In addition, a weight ratio of the first phosphor, one of the second phosphors, and the other second phosphor may be about 3:2:5 to about 5:3:2. Also, the weight ratio may vary according to desired properties of a PDP.

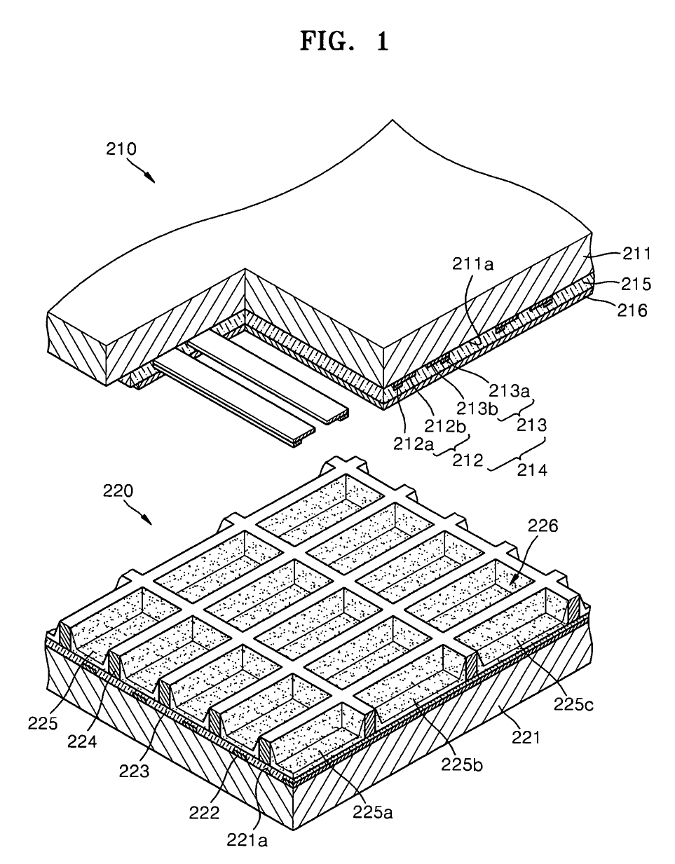

An embodiment provides a PDP including the green phosphor or green phosphor composition. The PDP may include a transparent front substrate and a rear substrate substantially parallel to the front substrate. The PDP may also include discharge cells partitioned by barrier ribs disposed between the front substrate and the rear substrate. Pairs of sustain electrodes may extend in a first direction and address electrodes may extend in a second direction crossing the first direction and corresponding to the discharge cells. A rear dielectric layer may cover the address electrodes. Red, green and blue phosphor layers may be disposed in the discharge cells. A front dielectric layer may cover the pairs of sustain electrodes. A discharge gas may fill the discharge cells. The PDP will now be described with reference to FIG. 1.

Referring to FIG. 1, the PDP may include a front panel 210 and a rear panel 220. The front panel 210 may include a front substrate 211 and pairs of sustain electrodes 214 disposed on a rear surface of the front substrate 211 and extending in a first direction to correspond to the discharge cells. A front dielectric layer 215 may cover the pairs of sustain electrodes 214. A protective layer 216 may cover the front dielectric layer 215.

The rear panel 220 may include a rear substrate 221 substantially parallel to the front substrate 211. Address electrodes 222 may be disposed on a front surface 221a of the rear substrate 221 and extend in a second direction substantially perpendicular to the first direction to cross the pairs of sustain electrodes 214. A rear dielectric layer 223 may cover the address electrodes 222. Barrier ribs 224 may be disposed between the front substrate 211 and the rear substrate 221, and more particularly on the rear dielectric layer 223, and may define a plurality of discharge cells 226. A red phosphor layer 225a, a green phosphor layer 225b, and a blue phosphor layer 225c, respectively formed of red, green, and blue phosphors may be disposed in the discharge cells 226.

According to the present embodiment, the green phosphor layer 225b may be formed of the above-mentioned LuAG:Ce phosphor or green phosphor composition. The red phosphor layer 225a and blue phosphor 225c may be formed of suitable materials that are typically used in a PDP. The red phosphor layer may include, e.g., (Y,Gd)BO₃:Eu, Y(V,P)O₄:Eu, etc. The blue phosphor layer may include, e.g., BaMgAl₁₀O₁₇:Eu, etc.

To easily form the phosphor layers for a PDP, the phosphor or a phosphor mixture (“phosphor”) may be mixed with a binder and a solvent to obtain a paste phase phosphor layer composition. Then, the paste phase phosphor composition may be, e.g., screen printed using a screen mesh to form a printed phosphor layer composition. Then, the printed phosphor layer composition may be dried and sintered to form a phosphor layer. The drying temperature of the printed phosphor layer composition may be about 100° C. to about 150° C., and the sintering temperature may be about 350° C. to about 600° C. Preferably the sintering temperature is about 450° C., which may help ensure removal of organic materials from the paste phase phosphor composition.

The binder may include, e.g., ethyl cellulose, an acryl resin, or the like. The binder may be used in an amount of about 10 to about 30 parts by weight based on 100 parts by weight of the phosphor. The solvent may include, e.g., butyl carbitol (BCA), terpineol, or the like. The solvent may be included in an amount of about 70 to about 300 parts by weight based on 100 parts by weight of the phosphor. The viscosity of the paste phase composition may be about 5,000 to about 50,000 cps, and preferably, about 20,000 cps.

The phosphor layer composition according to the present embodiment may further include additives, e.g., a dispersant, a plasticizer, an antioxidant, a leveler, or the like, if necessary. The amount of the additives may be about 0.1 to about 10 parts by weight based on the total weight of the phosphor layer composition.

The front substrate 211 and the rear substrate 221 may generally be formed of glass. The front substrate 211 may have high light transmittance.

The address electrodes 222 may include a metal having high electrical conductivity, e.g., Al. The address electrodes 222 may be used together with an X electrode 213 or a Y electrode 212 of the sustain electrode pair 214 to cause an address discharge. The address discharge selects a discharge cell 226 for emitting light. Once an address discharge has occurred in the discharge cell 226, a sustain discharge, which will be described below, may occur.

The address electrodes 222 may be covered by the rear dielectric layer 223. The rear dielectric layer may protect the address electrodes 222 by preventing the address electrodes 222 from being bombarded with charged particles generated during the address discharge. The rear dielectric layer 223 may be formed of a dielectric material capable of inducing discharged particles. The dielectric material may include, e.g., PbO, B₂O₃, SiO₂, or the like.

The barrier ribs 224 defining the discharge cells 226 may be interposed between the front substrate 211 and the rear substrate 221. The barrier ribs 224 may define a discharge space between the front substrate 211 and the rear substrate 221, prevent crosstalk between adjacent discharge cells 226, and enlarge the surface area of the phosphor layer 225. The barrier ribs 224 may be formed of a glass material including, e.g., Pb, B, Si, Al, or O. When required, the barrier ribs 224 may further include a filler, e.g., ZrO₂, TiO₂, and Al₂O₃, and/or a pigment, e.g., Cr, Cu, Co, Fe, or TiO₂.

The pairs of sustain electrodes 214 may extend in the first direction substantially perpendicular to the second direction and correspond to the discharge cells 226. The pairs of sustain electrodes 214 may be disposed substantially parallel to each other at predetermined intervals on the front substrate 211. The pairs of sustain electrodes 214 may each include the Y electrode 212 and the X electrode 213. Sustain discharge may occur due to a potential difference between the X electrode 213 and the Y electrode 212.

The X electrode 213 and the Y electrode 212 may each include transparent electrodes 213b and 212b and bus electrodes 213a and 212a, respectively. In some cases, however, only the bus electrodes 213a and 212a may be used to form both a scanning electrode and a common electrode.

The transparent electrodes 213b and 212b may be formed of a conductive and transparent material, so that the light emitted from the phosphor may pass through the front substrate 211 without being blocked. The conductive and transparent material may include, e.g., indium tin oxide (ITO). However, if the sustain electrodes 214 only include the transparent electrodes 213b and 212b, the sustain electrodes 214 may have an undesirably large voltage drop in a lengthwise direction, because the conductive and transparent material may have a high resistance. In addition, the power consumption of the PDP may undesirably increase, and the response speed of images may undesirably decrease. In order to avoid these problems, the bus electrodes 213a and 212a may be formed of a highly conductive metal, e.g., Ag, and be disposed at outer edges of the transparent electrodes 213b and 212b.

The Y electrode 212 and X electrode 213 may be covered by the front dielectric layer 215. The front dielectric layer 215 may electrically insulate the X electrode from the Y electrode, and may protect the sustain electrode pairs 214 by preventing the sustain electrode pairs 214 from being bombarded by charged particles generated during discharge. The front dielectric layer 215 may be formed of a dielectric material having high light transmittance, e.g., PbO, B₂O₃, or SiO₂.

The protective layer 216 may be formed on the front dielectric layer 215. The protective layer 216 may prevent collisions of charged particles with the front dielectric layer 215 during sustain discharge, protecting the front dielectric layer 215. The protective layer 216 may also generate secondary electrons during the sustain discharge. The protective layer 216 may be formed of, e.g., MgO.

The discharge cells 226 may be filled with a discharge gas. The discharge gas may include, e.g., a gaseous mixture of Ne and Xe, in which an amount of Xe may be about 5 to about 10%. When needed, e.g., when increased stability of discharge is required, a part of Ne may be replaced with He.

The PDP is not limited to the structure illustrated in FIG. 1 and may have other structures.

The embodiments will be described in further detail with reference to the following examples. These examples are for illustrative purposes only and are not intended to limit the scope.

### Preparation of a Green Phosphor

### Preparation Examples 1 through 7

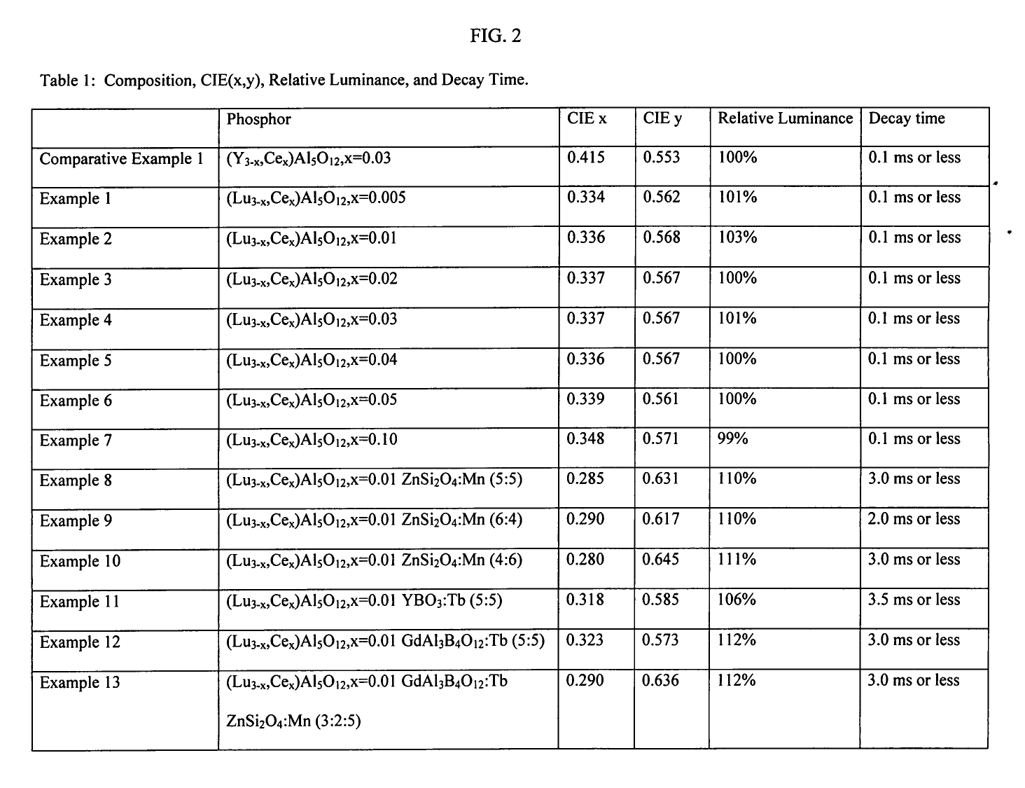

In order to prepare green phosphors according to Preparation Examples 1 through 7, Lu₂O₃, Al₂O₃, and CeO₂, as precursors, were quantified according to chemical equivalent weight ratio so as to prepare phosphors according to Examples 1 through 7 in Table 1 of FIG. 2. The precursors were mixed by a V-mixer, and baked at 1500° C. for 7 hours under a carbon atmosphere so as to obtain the green phosphors according to Preparation Examples 1 through 7.

A median diameter D₅₀ of particles of the green phosphor according to Preparation Example 3, which was measured using a Coulter counter, was 2.1 μm.

Median diameters of ZnSi₂O₄:Mn, YBO₃:Tb, and GdAl₃B₄O₁₂:Tb phosphor particles used in the following green phosphor compositions were 2.6 μm, 3.4 μm, and 2.7 μm, respectively.

### Preparation Example of a Green Phosphor Composition

### Preparation Example 8

A green phosphor composition was prepared by dry mixing 50 parts by weight of the green phosphor prepared in Preparation Example 3 and 50 parts by weight of a ZnSi₂O₄:Mn phosphor.

### Preparation Example 9

A green phosphor composition was prepared by dry mixing 60 parts by weight of the green phosphor prepared in Preparation Example 3 and 40 parts by weight of a ZnSi₂O₄:Mn phosphor.

### Preparation Example 10

A green phosphor composition was prepared by dry mixing 40 parts by weight of the green phosphor prepared in Preparation Example 3 and 60 parts by weight of a ZnSi₂O₄:Mn phosphor.

### Preparation Example 11

A green phosphor composition was prepared by dry mixing 50 parts by weight of the green phosphor prepared in Preparation Example 3 and 50 parts by weight of a YBO₃:Tb phosphor.

### Preparation Example 12

A green phosphor composition was prepared by dry mixing 50 parts by weight of the green phosphor prepared in Preparation Example 3 and 50 parts by weight of a GdAl₃B₄O₁₂:Tb phosphor.

### Preparation Example 13

A green phosphor composition was prepared by dry mixing 30 parts by weight of the green phosphor prepared in Preparation Example 3, 20 parts by weight of a GdAl₃B₄O₁₂:Tb phosphor, and 50 parts by weight of a ZnSi₂O₄:Mn phosphor.

### Manufacturing Example of a PDP

### Examples 1 through 13

Phosphor slurries were prepared by mixing 40 parts by weight of the green phosphors and green phosphor compositions prepared in Preparation Examples 1 through 13, respectively, 52 parts by weight of terpineol as a solvent, and 8 parts by weight of ethyl cellulose as a binder. PDPs according to Examples 1 through 13 were manufactured by screen printing each phosphor slurry on a discharge cell of the PDP, and drying and baking the printed phosphor slurries at 480° C. to form green phosphor layers. The composition of discharge gases in the PDP was adjusted to 93 weight % of Ne and 7 weight % Xe.

### Comparative Example 1

A PDP was manufactured in the same manner as in Example 1, except that 40 parts by weight of (Y_{2.97},Ce_{0.03})Al₅O₁₂ was used instead of LuAG:Ce. Table 1 shows the estimation result of the manufactured PDP.

x and y chromaticity coordinate (CIE x, CIE y), relative luminance, and decay time of the green phosphor layers in the PDPs were measured, and the measurement results are shown in Table 1. The relative luminance is a relative value with respect to a phosphor prepared according to Comparative Example 1. In addition, the decay time is a time, measured by an oscilloscope, taken until luminance is reduced to 1/10 while a pulsed Xe lamp excitation ray proceeds.

TABLE 1

| | | CIE | CIE | Relative | Decay |
|---|---|---|---|---|---|
| | Phosphor | x | y | Luminance | time |
| Comparative | (Y₃₋ₓ,Ceₓ)Al₅O₁₂, x = 0.03 | 0.415 | 0.553 | 100% | 0.1 ms |
| Example | | | | | or less |
| Example 1 | (Lu₃₋ₓ,Ceₓ)Al₅O₁₂, x = 0.005 | 0.334 | 0.562 | 101% | 0.1 ms |
| | | | | | or less |
| Example 2 | (Lu₃₋ₓ,Ceₓ)Al₅O₁₂, x = 0.01 | 0.336 | 0.568 | 103% | 0.1 ms |
| | | | | | or less |
| Example 3 | (Lu₃₋ₓ,Ceₓ)Al₅O₁₂, x = 0.02 | 0.337 | 0.567 | 100% | 0.1 ms |
| | | | | | or less |
| Example 4 | (Lu₃₋ₓ,Ceₓ)Al₅O₁₂, x = 0.03 | 0.337 | 0.567 | 101% | 0.1 ms |
| | | | | | or less |
| Example 5 | (Lu₃₋ₓ,Ceₓ)Al₅O₁₂, x = 0.04 | 0.336 | 0.567 | 100% | 0.1 ms |
| | | | | | or less |
| Example 6 | (Lu₃₋ₓ,Ceₓ)Al₅O₁₂, x = 0.05 | 0.339 | 0.561 | 100% | 0.1 ms |
| | | | | | or less |
| Example 7 | (Lu₃₋ₓ,Ceₓ)Al₅O₁₂, x = 0.10 | 0.348 | 0.571 | 99% | 0.1 ms |
| | | | | | or less |
| Example 8 | (Lu₃₋ₓ,Ceₓ)Al₅O₁₂, x = 0.01 | 0.285 | 0.631 | 110% | 3.0 ms |
| | ZnSi₂O₄:Mn (5:5) | | | | or less |
| Example 9 | (Lu₃₋ₓ,Ceₓ)Al₅O₁₂, x = 0.01 | 0.290 | 0.617 | 110% | 2.0 ms |
| | ZnSi₂O₄:Mn (6:4) | | | | or less |
| Example 10 | (Lu₃₋ₓ,Ceₓ)Al₅O₁₂, x = 0.01 | 0.280 | 0.645 | 111% | 3.0 ms |
| | ZnSi₂O₄:Mn (4:6) | | | | or less |
| Example 11 | (Lu₃₋ₓ,Ceₓ)Al₅O₁₂, x = 0.01 | 0.318 | 0.585 | 106% | 3.5 ms |
| | YBO₃:Tb (5:5) | | | | or less |
| Example 12 | (Lu₃₋ₓ,Ceₓ)Al₅O₁₂, x = 0.01 | 0.323 | 0.573 | 112% | 3.0 ms |
| | GdAl₃B₄O₁₂:Tb (5:5) | | | | or less |
| Example 13 | (Lu₃₋ₓ,Ceₓ)Al₅O₁₂, x = 0.01 | 0.290 | 0.636 | 112% | 3.0 ms |
| | GdAl₃B₄O₁₂:Tb ZnSi₂O₄:Mn | | | | or less |
| | (3:2:5) | | | | |

As shown in Table 1, it may be seen that when the green phosphors according to Examples 1 to Example 7 are used, a PDP having an improved color coordinate in addition to excellent properties with regard to decay time and relative luminance may be obtained.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A green phosphor for a plasma display panel (PDP), comprising:
a green phosphor represented by Formula 1: (Lu₃₋ₓ,Ceₓ)Al₅O₁₂, wherein in Formula 1, x satisfies the relation 0<x<3.

2. The green phosphor as claimed in claim 1, wherein in Formula 1, x satisfies the relation 0.001≦x≦0.5.

3. The green phosphor as claimed in claim 2, wherein in Formula 1, x satisfies the relation 0.001≦x≦0.05.

4. The green phosphor as claimed in claim 1, wherein the green phosphor has a median particle diameter D₅₀ of about 1 to about 4 μm.

5. A green phosphor composition for a PDP, comprising:
a first phosphor represented by Formula 1: (Lu₃₋ₓ,Ceₓ)Al₅O₁₂, wherein in Formula 1, x satisfies the relation 0<x<3; and
a second phosphor including at least one of ZnSi₂O₄:Mn, YBO₃:Tb, BaMgAl₁₄O₂₃:Mn, and GdAl₃B₄O₁₂:Tb.

6. The green phosphor composition as claimed in claim 5, wherein the first phosphor and the second phosphor are included in a weight ratio of about 3:7 to about 7:3.

7. The green phosphor composition as claimed in claim 5, wherein in Formula 1, x satisfies the relation 0.001≦x≦0.5.

8. The green phosphor composition as claimed in claim 7, wherein in Formula 1, x satisfies the relation 0.001≦x≦0.05.

9. A PDP, comprising:
a front substrate, wherein the front substrate is transparent;
a rear substrate parallel to the front substrate;
discharge cells divided by barriers disposed between the front substrate and the rear substrate;
address electrodes extending to correspond to the discharge cells disposed in one direction;
a rear dielectric layer covering the address electrodes;
red, green, and blue phosphor layers disposed in the discharge cells;
pairs of sustain electrodes extending in a direction crossing the direction in which the address electrodes extend;
a front dielectric layer covering the pairs of sustain electrodes; and
a discharge gas filling the discharge cell,
wherein the green phosphor layer includes a green phosphor represented by Formula 1: (Lu₃₋ₓ,Ceₓ)Al₅O₁₂, and in Formula 1, x satisfies the relation 0<x<3.

10. The PDP as claimed in claim 9, wherein in Formula 1, x satisfies the relation 0.001≦x≦0.5.

11. The PDP as claimed in claim 10, wherein in Formula 1, x satisfies the relation 0.001≦x≦0.05.

12. The PDP as claimed in claim 9, wherein the green phosphor has a median particle diameter D₅₀ of about 1 to about 4 μm.

13. The PDP as claimed in claim 9, wherein the green phosphor layer further includes a second phosphor including at least one of ZnSi₂O₄:Mn, YBO₃:Tb, BaMgAl₁₄O₂₃:Mn, and GdAl₃B₄O₁₂:Tb.

14. The PDP as claimed in claim 13, wherein the first phosphor and the second phosphor are included in a weight ratio of about 3:7 to about 7:3.

15. The PDP as claimed in claim 13, wherein in Formula 1, x satisfies the relation 0.001≦x≦0.5.

16. The PDP as claimed in claim 15, wherein in Formula 1, x satisfies the relation 0.001≦x≦0.05.
